(19) United States
(12) Patent Application Publication
(10) Pub. No.: US 2008/0005167 A1
(43) Pub. Date: Jan. 3, 2008

(54) METHOD, SYSTEM, AND COMPUTER PROGRAM PRODUCT FOR MANAGING CONTENT RECEIVED FROM MULTIPLE CONTENT FEEDS

(75) Inventors: Frank L. Jania, Chapel Hill, NC (US); Darren M. Shaw, Hampshire (GB)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/427,873

(22) Filed: Jun. 30, 2006

(51) Int. Cl. G06F 17/00

(52) U.S. Cl. 707/104.1

(57) ABSTRACT

A method, system, and computer program product for managing content received from multiple content feeds is provided. The method includes analyzing content articles received from multiple content feeds to identify common subject matter among the content articles, grouping related content articles across the multiple content feeds resulting from the analyzing, and assigning a descriptor to the related content articles and placing the descriptor in a topical index for related content. The method also includes creating a link for the descriptor that links the descriptor to the related content articles and displaying the topical index including the link. When the link is selected, the method includes creating a container, presenting the related content articles in the container, and marking each of the related content articles as read in corresponding content feeds.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to content feed aggregation, and particularly to a method, system, and computer program product for managing content received from multiple content feeds.

2. Description of Background

Various products and services relating to content feed aggregation provide users with a view of selected articles aggregated from content providers that syndicate content through feeds. Types of content providers include, e.g., Weblogs, podcasts, vlogs, and mass media Web sites. The syndicated content is provided to the users in the form of a Web feed, such as RSS Atom, XML formats, etc.).

In addition, various service providers have entered the market by providing portal sites for hosting personal Web pages of aggregated content for its customers (e.g., My Yahoo™, Mozilla Firefox™, and Safari™, to name a few). Users of these services are presented with the aggregated content via a browser display on a computer processing system. By contrast, client side applications incorporate features of the feed aggregation, such as a user's Web browser application.

With the growing popularity of content feed services, there has been a surge in the number of content feed providers entering the market. Users that subscribe to multiple content providers often find duplications in the articles presented in the aggregated content view, i.e., each of the duplicate articles occupy a separate space, or container, on the display screen. As more feeds are added to a user's list, reviewing each of the common articles individually becomes more cumbersome.

What is needed, therefore, is a way to identify duplicate content articles across multiple content feeds and present a consolidated representation of the duplicate content.

### SUMMARY OF THE INVENTION

The shortcomings of the prior art are overcome and additional advantages are provided through the provision of a method for managing content received from multiple content feeds is provided. The method includes analyzing content articles received from multiple content feeds to identify common subject matter among the content articles, grouping related content articles across the multiple content feeds resulting from the analyzing, and assigning a descriptor to the related content articles and placing the descriptor in a topical index for related content. The method also includes creating a link for the descriptor that links the descriptor to the related content articles and displaying the topical index including the link. When the link is selected, the method includes creating a container, presenting the related content articles in the container, and marking each of the related content articles as read in corresponding content feeds.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which identifies duplicate content articles across multiple content feeds and presents a consolidated representation of the duplicate content.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of block diagram of a system upon which the content management processes may be implemented in accordance with exemplary embodiments

FIG. 2 illustrates one example of a flow diagram describing a process for implementing the content management processes in exemplary embodiments; and

FIG. 3 illustrates one example of a user interface screen depicting a consolidated view of content articles prepared via the content management processes in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, content management processes are provided that identify duplicate content articles across multiple content feeds and present a consolidated representation of the duplicate content.

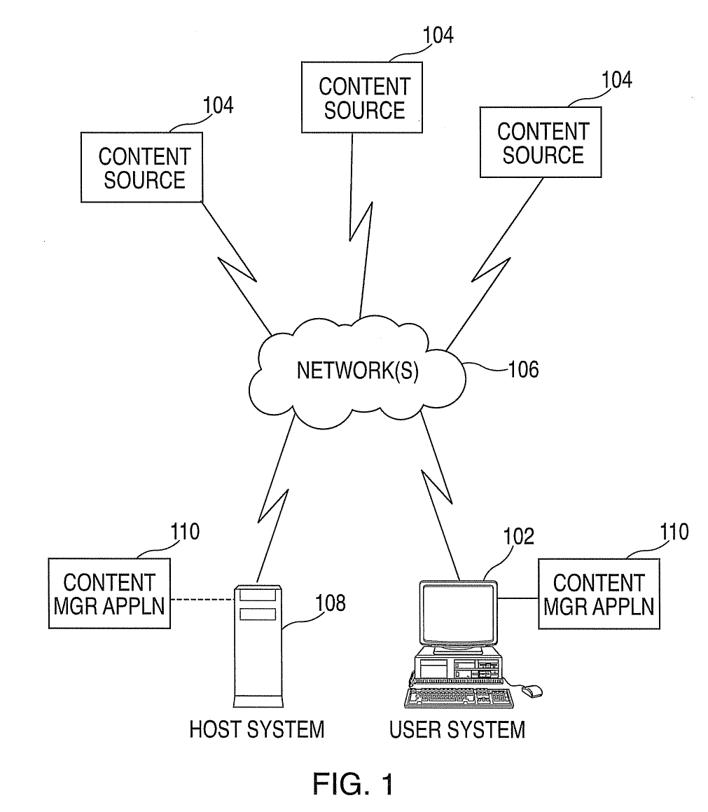

Turning now to FIG. 1, a system upon which the content management processes may be implemented in accordance with exemplary embodiments will now be described. The system of FIG. 1 includes a user system 102 in communication with content sources 104 via one or more networks 106. User system 102 represents a consumer or subscriber of the content management services described herein. User system 102 may be implemented using a general-purpose computer executing a computer program for carrying out the processes described herein. The user system 102 may be a personal computer (e.g., a lap top, a personal digital assistant) or host attached terminal. In exemplary embodiments, the user system 102 executes a content manager application 110 for implementing the content management processes described herein.

Content sources 104 refer to content providers that syndicate content through feeds. Content sources 104 may provide, e.g., Weblogs, podcasts, vlogs, etc. The syndicated content (e.g., content articles) may be provided to the user system 102 in the form of a Web feed, such as RSS Atom, XML formats, etc. Content sources 104 may be implemented using a high-speed processing device for handling a large volume of content feed requests over network 106.

In alternative embodiments, a host system 108 may be implemented for providing the content management processes. Host system 108 refers to a service provider that provides a portal site for hosting personal Web pages of aggregated content for its users. Host system 108 may be implemented by an Internet service provider, application service provider, Web service enterprise, or other similar entity. Users (e.g., user system 102) of the services provided by host system 108 may be presented with aggregated content via browser display on the user's processing system. Host system 108 may be implemented using one or more servers operating in response to a computer program stored in a storage medium accessible by the server(s).

Network(s) 106 may be implemented using any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A user system 102 may be coupled to the host system 108 and/or content sources 104 through multiple networks (e.g., intranet and Internet) so that not all user systems 102 are coupled to the host system 108 and/or content sources 104 through the same network. One or more user systems 102 and the host system 108 may be connected to the network 106 in a wireless fashion.

With the growing popularity of content feed services, there has been an increase in the number of content feed providers entering the market. Users that subscribe to multiple content providers often find duplications in the articles presented in the aggregated content view, i.e., each of the duplicate articles occupy a separate space, or container, on the display screen. As more feeds are added to a user's list, reviewing each of the common articles individually becomes more cumbersome. The content management processes eliminates this problem by identifying duplicate or similar content articles across multiple content feeds and presenting a consolidated representation of the duplicate content in a single view. Similar or related content may be defined as content that shares identical or substantially similar subject matter, such that a review of subsequent content articles determined to be similar or related to a first article would produce little or no new information for the reader.

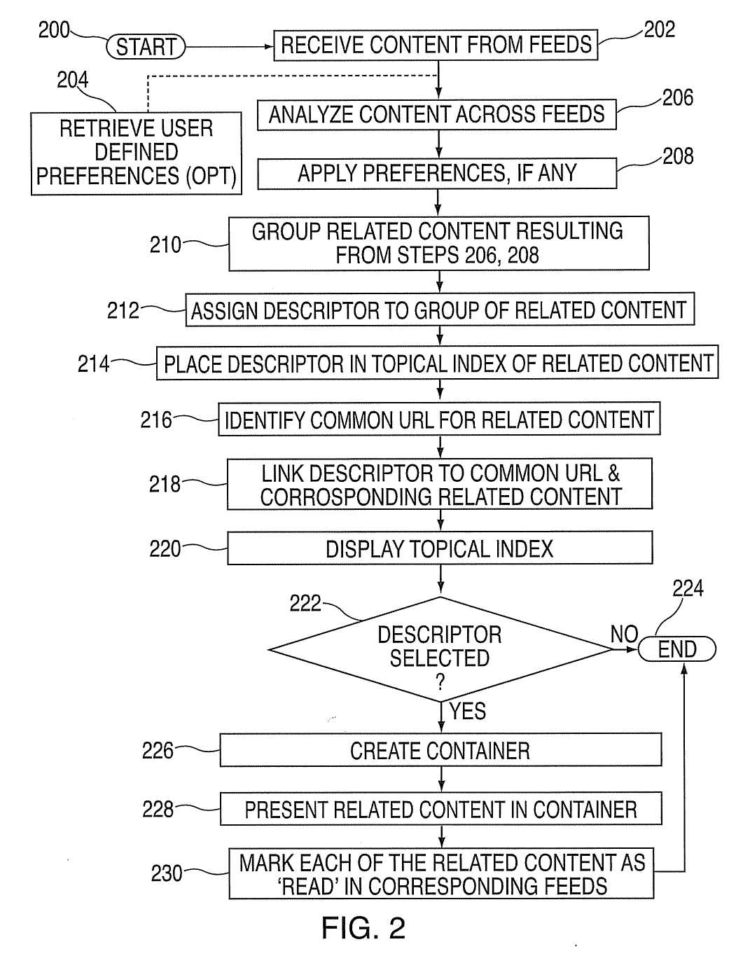

Turning now to FIG. 2, a process for implementing the content management services will now be described in exemplary embodiments. For purposes of illustration, the content management processes will be described with reference to a client-side application (e.g., content manager application 110 executing on the user system 102). However, it will be understood by those skilled in the art that these processes may be provided by a third party entity, e.g., host system 108. Content manager application 110 provides a user interface whereby a user of user system 102 may establish preferences available (e.g., for handling or processing content articles) via the content management processes. Available preferences may include system status indicators (e.g., whether the system is activated), techniques to be applied to generate the grouped content, list of domains to be excluded from a grouping, a specified depth of URL linking to be processed, to name a few. These preferences are stored for later access by the content manager application 110 as described further herein.

The process begins at step 200 whereby user at user system 102 receives content from content sources 104 at step 202. The content manager application 110 retrieves the user preferences established by the user, if any, at step 204 and analyzes the content articles provided by the content sources 104 via the feeds at step 206. Content articles may include news articles, images, video materials, audio content, email messages, multi-media content, etc.

The analysis may be performed using one or more techniques. For example, the each of the content articles may be parsed and examined for key word matches. Common terms, e.g., “a”, “the”, “at”, “and”, etc., may be removed or filtered from the parsed content. In addition, document clustering techniques may be used via text analysis (e.g., clustering software) that creates clusters of similar documents with common subject matter or topical matter based upon, e.g., the key word matches.

Alternatively, or in combination with the above, common uniform resource locator (URL) references may be identified from the content articles across the content feeds. Many duplicate articles are found to reference a common web site or URL, or may reference a web site/URL that eventually leads to a common URL. Path analysis techniques may be utilized to see if the links lead to the same source (e.g., URL or website). The content of the feed may be parsed to identify any URLs. Any identified URLs pointing to the same domain as the feed came from may be discarded, leaving only external URLs. If multiple articles have external URLs pointing to a single source site, then it may be assumed that the entries are on the same subject and can be combined under a single topic or category by the content management processes.

At step 208, any user preferences established may be applied to the results of the analysis.

Content articles determined to be similar or related as a result of the analysis provided in step 206 and the user preferences applied in step 208 are grouped together by the content manager application 110 at step 210. At step 212, a descriptor is assigned to the grouped content to identify the topic of the content. The descriptor is placed in a topical index created by the content manager application 110 at step 214. The topical index provides a listing of topics by descriptor for various groups of related content as determined by the above processes recited above in FIG. 2.

At step 216, a common URL for the related content is identified. For example, suppose that each of the content articles in the group refer to a new web site recently launched. The common URL may be the URL of the new web site. In another example, a new product may be launched by an enterprise whereby each of the content articles reference the new product and the enterprise website. The common URL identified in step 216 would be the enterprise URL.

At step 218, the descriptor is linked to the common URL and corresponding related content (i.e., the group). The linking may be implemented using standard protocols, e.g., HTML links. The topical index is displayed at the user system 102, e.g., on the Web browser view at step 220.

The user may view content articles from various content sources via the view using standard techniques or may implement the consolidated feature of the content management processes via the topical index. At step 222, it is determined whether the user has selected a descriptor in the topical index. If not, the process ends at step 224 whereby standard content review techniques are employed.

Otherwise, if a descriptor link has been selected at step 222, the content manager application 110 creates a new container, or space, at step 224 and presents each of the related content articles in the container at step 228, along with a reference link for the common URL.

At step 230, the content manager application 110 marks, or flags, each of the related content articles in the group as ‘read’ within each of the articles' corresponding feeds.

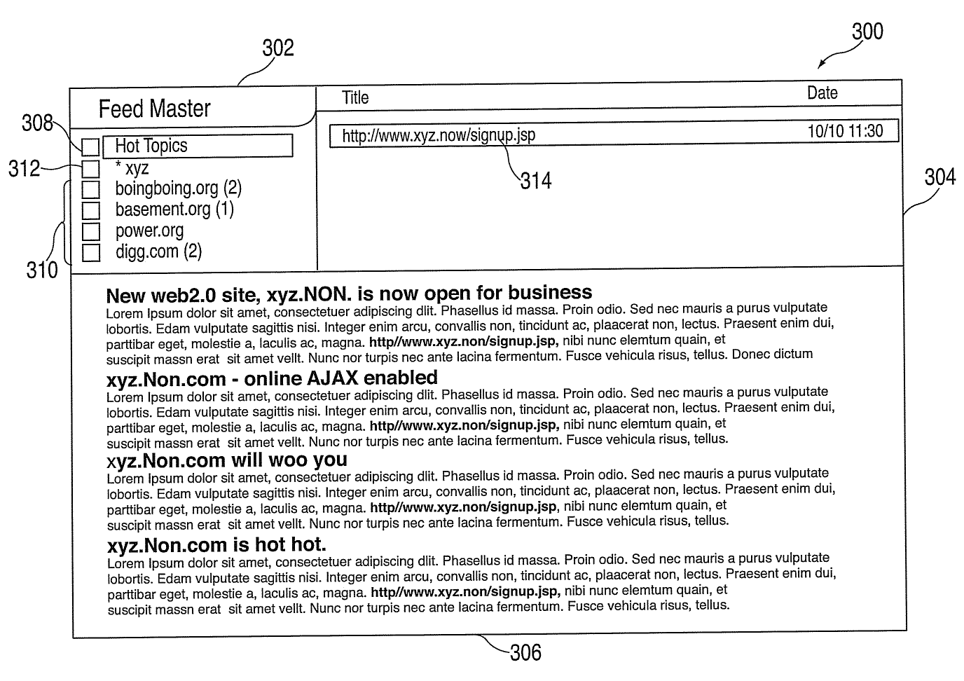

Turning now to FIG. 3, a sample user interface screen 300 depicting a Web browser view of consolidated content provided by the content management services is shown in exemplary embodiments. The user interface screen 300 illustrates three content panes 302, 304 and 306. Content pane 302 provides a topic directory 308 followed by with content feed sources 310. The topic directory 308 contains one entry, or descriptor 312 identifying a group of related content articles that were found across the content feed sources 310. When the user selects the descriptor 312, the second pane 304 displays the common URL 314 identified for the descriptor. The third content pane 306 displays the content articles identified for the group (i.e., related content articles). By selecting the descriptor 312, the content manager application 110 flags the related content articles in the content feeds as ‘read’ so that the user is aware that these articles have been reviewed, even if the user does not review every article in the content pane 306, thereby saving the user time and effort.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for managing content received from multiple content feeds, comprising:
analyzing content articles received from multiple content feeds to identify common subject matter among the content articles;
grouping related content articles across the multiple content feeds resulting from the analyzing;
assigning a descriptor to the related content articles and placing the descriptor in a topical index for related content;
creating a link for the descriptor that links the descriptor to the related content articles;
displaying the topical index including the link; and
upon selection of the link, performing:
creating a container;
presenting the related content articles in the container; and
marking each of the related content articles as read in corresponding content feeds.

2. The method of claim 1, further comprising accessing user-defined preferences for handling content articles, wherein the analyzing includes applying the user-defined preferences to the content articles, the user-defined preferences including:
system status indicators;
techniques for generating grouped content;
a list of domains to be excluded from a grouping; and
a specified depth of uniform resource locator (URL) linking to be processed.

3. The method of claim 1, further comprising:
identifying a common uniform resource locator (URL) for the related content articles;
linking the descriptor to the common URL; and
presenting the common URL when the link to the descriptor is selected.

4. The method of claim 1, wherein the analyzing includes:
parsing each of the content articles, filtering out common terms, and examining the parsed, filtered content for key word matches;
clustering the content articles into groups based upon the key word matches that identify similar or related subject matter; and
using a common URL found within the content articles or referenced by the content articles and grouping the content articles according to the common URL.

5. A system for managing content received from multiple content feeds, comprising:
a computer processing device; and
a content manager application executing on the computer processing device, the content manager application performing:
analyzing content articles received from multiple content feeds to identify common subject matter among the content articles;
grouping related content articles across the multiple content feeds resulting from the analyzing;
assigning a descriptor to the related content articles and placing the descriptor in a topical index for related content;
creating a link for the descriptor that links the descriptor to the related content articles;
displaying the topical index including the link; and
upon selection of the link, performing:
creating a container;
presenting the related content articles in the container; and
marking each of the related content articles as read in corresponding content feeds.

6. The system of claim 5, wherein the content manager application further performs accessing user-defined preferences for handling content articles, wherein the analyzing includes applying the user-defined preferences to the content articles, the user-defined preferences including:
system status indicators;
techniques for generating grouped content;
a list of domains to be excluded from a grouping; and
a specified depth of uniform resource locator (URL) linking to be processed.

7. The system of claim 5, wherein the content manager application further performs:
identifying a common uniform resource locator (URL) for the related content articles;
linking the descriptor to the common URL; and
presenting the common URL when the link to the descriptor is selected.

8. The system of claim 5, wherein the analyzing includes:
parsing each of the content articles, filtering out common terms, and examining the parsed, filtered content for key word matches;
clustering the content articles into groups based upon the key word matches that identify similar or related subject matter; and
using a common URL found within the content articles or referenced by the content articles and grouping the content articles according to the common URL.

9. A computer program product for managing content received from multiple content feeds, the computer program product including instructions for implementing a method, comprising:
analyzing content articles received from multiple content feeds to identify common subject matter among the content articles;
grouping related content articles across the multiple content feeds resulting from the analyzing;
assigning a descriptor to the related content articles and placing the descriptor in a topical index for related content;
creating a link for the descriptor that links the descriptor to the related content articles;
displaying the topical index including the link; and
upon selection of the link, performing:
creating a container;
presenting the related content articles in the container; and
marking each of the related content articles as read in corresponding content feeds.

10. The computer program product of claim 9, further comprising instructions for implementing:
accessing user-defined preferences for handling content articles, wherein the analyzing includes applying the user-defined preferences to the content articles, the user-defined preferences including:
system status indicators;
techniques for generating grouped content;
a list of domains to be excluded from a grouping; and
a specified depth of uniform resource locator (URL) linking to be processed.

11. The computer program product of claim 9, further comprising instructions for implementing:
identifying a common uniform resource locator (URL) for the related content articles;
linking the descriptor to the common URL; and
presenting the common URL when the link to the descriptor is selected.

12. The computer program product of claim 1, wherein the analyzing includes:
parsing each of the content articles, filtering out common terms, and examining the parsed, filtered content for key word matches;
clustering the content articles into groups based upon the key word matches that identify similar or related subject matter; and
using a common URL found within the content articles or referenced by the content articles and grouping the content articles according to the common URL.
